(19) United States
(12) Patent Application Publication
(10) Pub. No.: US 2011/0171439 A1
(43) Pub. Date: Jul. 14, 2011

(54) LAMINATE AND COMPOSITE LAYER COMPRISING A SUBSTRATE AND A COATING, AND A PROCESS AND APPARATUS FOR PREPARATION THEREOF

(76) Inventors: Shahab Jahromi, Maastricht (NL); Constantinus Simon Maria Liebregts, Helmond (NL)

(21) Appl. No.: 13/003,221

(22) PCT Filed: Jul. 7, 2009
(86) PCT No.: PCT/EP2009/058611

§ 371 Date: Apr. 1, 2011

(30) Foreign Application Priority Data
Jul. 8, 2008 (EP) 08159945.8

(51) Int. Cl. B32B 3/00; B32B 15/04; B32B 19/00

(52) U.S. Cl. 428/209; 428/457; 428/702; 428/195.1

(57) ABSTRACT

The invention relates to a laminate comprising two plastic films and (optionally in between a metal or metal oxide layer and) a layer of an organic compound other than triazine, the laminate having a lamination strength of about 2 N/inch or more as measured in a 90 degree tensile testing at 30 mm/min. The invention further relates to a composite layer, suitable for said laminate. The invention further relates to laminate having a crystalline organic compound other than triazine to improve the barrier properties.

The invention relates to a laminate comprising two plastic films with good barrier and adhesion properties. The invention further relates to a composite layer comprising a substrate, a metal or metal oxide and a coating, a process and an apparatus for the preparation thereof.

Laminates are used in the packaging, electronic and other industries. Often, the laminates need good barrier properties like low oxygen or water vapour transmission rates. Plastic or paper films need to be coated with one or more layers improving the barrier properties. Yet, the adhesion between the films needs to be sufficiently high. Substrates, for example polyolefin or polyester films coated with a metal or metal oxide, like e.g. aluminum, aluminum oxide, magnesium oxide or silicium oxide are known. These films are likewise used in the packaging or electronic industry. Such films can have good barrier properties, however the processing of such metal or metal oxide layers that are used to enhance barrier properties may be difficult. For example, alumina coated films are deteriorated for further processing within a few month. Hence, before a next step, the alumina layer is corona treated. Obviously, this causes a delay in processing, and it is costly. Also, the metal or metal oxide layer may be damaged on micro-level by for example printing or further processing. It would be advantageous if the metal or metal oxide layer could be protected with a further coating. Sometimes, a coating is applied off line in a separate process step. The composite layer so obtained is further laminated with e.g. a further polyolefin film while using an adhesive. Melamine barrier films generally are deteriorated by moisture.

It would be furthermore advantageous to provide a layer with barrier properties that requires only soft deposition conditions, yet has barrier properties that are less moisture sensitive than melamine. By soft deposition conditions, we mean evaporation temperatures below 500° C. and vacuum pressures below 10⁻³ mbar. In comparison the vapour deposition of inorganic materials, such as aluminum, is carried at deposition temperatures above 1500° C. and vacuum pressure above 10⁻³ mbar.

It would be furthermore advantageous to have such soft deposition for layers acting as dielectric coating.

It is an object of this invention to provide an alternative barrier film, in which disadvantages of the prior art are at least partly overcome.

It is a further object of the invention is to provide a laminate comprising a substrate, a metal or metal oxide barrier layer with a protective layer having good processing properties and a good lamination strength.

Another object of the invention is to provide a composite layer comprising a substrate, a metal or metal oxide barrier layer with a protective layer that can be applied in line.

Another object of the invention is to provide a composite layer comprising a substrate, a vapour deposited crystalline organic compound, a metal or metal oxide layer. Both metal or metal oxide layer and organic compounds are applied in line.

Another object of the invention is to provide a composite layer comprising a substrate, a metal or metal oxide barrier layer with a protective layer such that the barrier layer is printable.

Yet another object is to find further compounds that are useful in improving the consistency of surface tension of metal layers after prolonged storage.

Laminates of this invention comprise a substrate layer and a plastic film and in between a vapour deposited crystalline organic compound layer other than triazine, the laminate having a lamination strength of about 2 N/25 mm (inch) or more as measured in a 90 degree tensile testing at 30 mm/min, and wherein the crystalline organic compound improves the barrier properties of the laminate.

In another embodiment, the laminates of this invention comprise a substrate layer and a plastic film and in between a vapour deposited organic compound layer other than triazine and a metal or metal oxide layer, the laminate having a lamination strength of about 2 N/25 mm (inch) or more as measured in a 90 degree tensile testing at 30 mm/min, and wherein the crystalline organic compound improves the barrier properties of the laminate.

In another embodiment of the invention, the laminate comprises a substrate, a metal layer, a vapour deposited crystalline organic compound layer other than triazine, and a further metal layer. The organic layer acts as an insulating layer between the two metal layers. Suitable examples of metal layers include but are not limited to: alumina, chromium, silver, gold, or copper.

The substrate layer preferably is also a plastic film.

The substrate may be pretreated with plasma treatment, and/or may comprise a primer. Suitable primers include crosslinkabe coatings like polyacrylate based coatings, epoxy based coatings and the like. These coatings preferably comprise nano-particle like for example silica, titaniumdioxide, ceriumoxide and the like. In a preferred embodiment, curable silica-based coatings appear to be very suitable, allowing barrier layers that are stable under high humidity.

In another embodiment, the composite layer of this invention comprises a substrate, a metal or metal oxide barrier layer with a protective layer that has been vapour deposited in line.

In a further embodiment of the present invention, the laminate comprises an adhesive layer between the organic compound layer and a plastic film.

In a further embodiment, the laminate comprises a pattern or figure on the organic compound layer layer.

In a further embodiment, a film is directly extruded on the organic compound layer, which may be printed.

Very useful transparent laminates can be made with the crystalline organic compounds which can be vapour deposited.

The organic compound layer may be a single or top layer, it is however also possible that on the layer of organic compound further layers are present, for example further layers of metal or metal oxide, a layer of triazine, printing or a polymer layer (laminating film).

The organic compound layer according to the invention may comprise in principle, any organic compound apart from a crystalline triazine compound. For example melamine, melam, melem and melon are excluded.

The organic compound preferably has a vapour pressure of about 1 Pa (0.01 mbar) or higher at 30° C. below its decomposition temperature. Preferably, the vapour pressure is about 10 Pa or higher. Generally, the vapour pressure will be about 1000 Pa (100 mbar) or lower.

For obtaining improved barrier properties, the compound should be crystalline, and have a Tm>50° C., preferably >100° C. For protecting the activity of alumina, it is preferred that the organic compound has a Tm (or Tg or rubbery-to-plastic phase-transition), of 70° C. or more, preferably 100° C. or more.

The Mw of the organic compound in general will be lower than 1000. Preferably, the organic compound is not polymerizing on the surface, as that causes substantial processing problems. Furthermore, the organic compound preferably is non-aliphatic (thus, it has ether, ester, amide, ketone groups and the like) such that the compound is sufficient polar to adhere well to the substrate.

The saturation pressure preferably is more than 4 times the square root of the molar mass of the compound divided by the absolute temperature at which the compound is evaporated in the heater.

The specific heat of sublimation preferably is about 0.5 kJ/g or higher, preferably about 0.6 kJ/g or higher. Generally, the specific heat of sublimation preferably is about 2 kJ/g or lower, more preferably about 1.5 kJ/g or lower, and most preferable about 1.2 kJ/g or lower.

In a further preferred embodiment, the organic compound comprises one or more groups that have the ability to form hydrogen bonds, such as for example —NH₂, —OH, —COOH, —NRH and the like.

In a further preferred embodiment, the organic compound comprises cyclic groups, such as one or more aromatic, cyclopentane, cyclopentene, cyclohexyl, admantane or cyclohexenyl groups; one or more aromatic groups are preferred.

In a further preferred embodiment, the cyclic ring comprises a hetrogeneous atom like oxygen, sulphur and preferably nitrogen like pyrimidine.

In a further preferred embodiment, the organic compound comprises of two aromatic rings which are linked together by a flexible spacer unit. The flexible unit may contain —NH—, or —CH2- groups.

Examples of suitable compounds include derivatives from pyrimidine trione, pyran-2,4,6-triol, bipyridine, naphtalenehexol, diamino-dihydro-oxo-pyrimodine, myo-inositol, diazozspiro-decane-trione, benzenetriol, cyclohexanetricarboxilic acid, hydroxybenzene-carboxilic acid, pyridinedicarboxilic acid esters, 9-methylanthracene, 9-methylcarbazole, dibenzothiophene, nonanedioic acid, 4,4′-azoxyanisole, 4-hydroxybenzaldehyde, triphenylamine, 4,4′-dichlorodiphenylsulphone, adipic acid, p-phenylphenol, p-aminophenol, aluminiumacetoacetonate, 3-hydroxy benzoic acid and terephthalic acid.

Unexpectedly, the organic compound layer protects the metal (in particular alumina) layer against de-activation. Unprotected alumina layers need corona treatment after some month of storage, in case a converter wants to make a laminate. It appears that the organic layer overcomes the necessity to perform a corona treatment, thereby saving money, and speeding-up the lamination process.

In a preferred embodiment, the organic compound layer also improves the barrier properties. The organic compound layer helps to protect the metal or metal-oxide layer against the impact of both soft roll (flexo) and hard roll (gravure) printing processes which are used to print films.

In a further preferred embodiment, the organic layer further improvers the printability, not only by protecting the metal or metal oxide layer, but also because it is a compound with better intrinsic printability characteristics.

In a further preferred embodiment the organic layer forms a continuous crystalline layer. Melamine forms a layer of micro-crystalline grains, which has the disadvantage than water can easily penetrate such a layer. A continuous crystalline layer is thought to be better resistant against water.

Very useful composite layers can be obtained by a substrate that is provided with a barrier layer and a protective layer, which protective layer can be made in one process sequence (after the step where the metal or metal oxide is applied and without rewinding the film), and, the protective layer further can improve the barrier properties.

The thickness of the organic compound layer as formed on the substrate in the vapour-depositing step depends on its intended purpose, and can thus vary within wide limits. Preferably, the thickness of the layer is about 5 μm or less, and even more preferably about 1 μm or less as with such lower thickness the transparency is improved. The thickness may be for example about 500 nm or less for cost reasons. The minimum thickness is preferably about 2 nm or more, more preferably about 10 nm or more, and even more preferred about 100 nm or more as such thickness improves the protective properties. For example, the thickness can be about 200 or 300 nm or more.

Preferably the composite layer, when laminated at the side of the organic compound layer with an adhesive and a plastic film is able to exhibit a lamination strength of about 2.5 N/inch or more, more preferably of about 3 N/inch or more, even more preferably of about 3.5 N/inch or more as measured with a tensile testing apparatus at 30 mm/min and at 90 degree. Generally, the upper limit of the lamination strength is not critical, but generally, this will be about 20 N/inch or less. The lamination of the composite layer for testing preferably is done with an appropriate urethane adhesive and laminated with a 10 μm thin polyethylene film. Thereafter, the lamination strength of the two films can be measured, and the failure mode can be observed. An appropriate adhesive is an adhesive that has such adhesion strength that the failure mode is not observed on the adhesion layer below 3.5 N/inch. The adhesion may be so high that the plastic film breaks. The value of the force necessary to break a film can in that case be taken as value for adhesion.

The substrate preferably has a vapour-deposited layer of a metal or metal oxide. Suitable metals and oxides include but are not limited to aluminium, copper, gold, silver, iron, magnesium, silicium or titanium. Preferred examples include aluminium, aluminium oxide, magnesium oxide or silicon oxide.

The metal or metal oxide generally is applied on the substrate by vapour deposition or sputtering. This process in generally is performed under vacuum. The metal or metal oxide layer generally has a thickness of about 1 nm or more, preferably about 3 nm or more. Generally, the thickness will be about 100 μm or less, preferably about 40 μm or less. Adhesion of the metal or metal layer to the substrate preferably is sufficiently strong to withstand tearing apart at 2 or 3 N/inch force. Adhesion may be dependent on the substrate, and for example for polyolefin films adhesion can be improved, in comparison with untreated substrates. Preferred methods to improve adhesion strength of the metal or metal oxide layer to a plastic layer include plasma, corona, UV radiation or electron beam treatment of the substrate.

The substrate comprises a material that serves as carrier, and this generally will be a plastic or paper in the form of a film or shape.

Generally, packaging materials are divided in flexible packaging and rigid packaging. Flexible packaging materials generally are based on film or sheet like materials, hereinafter named film. Rigid packaging generally has a certain shape (three dimensional form).

The composite layer according the invention, in particular the ones with a film as substrate may be used as such, but can also be applied on plastic, paper, cardboard, metal, in any shape or as an article, such as for example PET bottles.

In the case of rigid packaging, the substrate may be a plastic material, cardboard or paper material. Suitable examples of rigid packaging include bottles or pre-shaped packing boxes. Preferred examples of articles are articles made from PET or PP.

In one embodiment of the invention, the layer is part of a packing for food and drink products. Most preferred packaging products include a packing for coffee beans or milled coffee beans or a packing for beer.

In another embodiment, crystalline organic compound layers are unexpectedly suitable for use in solar systems, as either inorganic (crystalline and amorphous) or organic materials (dye-sensitized) must be protected against oxygen and water. An organic compound is an ideal barrier and encapsulation material for rigid and flexible thin-film photovoltaics with glass, plastic or metal as substrates depending on application. In particular crystalline organic compound layers are suitable in the manufacturing of solar cells based on various thin film technologies, including but not limited to using the following materials as photovoltaic compounds: Cadmium Tellluride, Copper-Indium Selenide (CIS), Copper Indium Gallium Diselenide (CIGS), Gallium arsenide (GaAs) multijunction, hybrid cells, Light-absorbing dyes (DSSC), Organic/polymer solar cells, Silicon Thin Films (amorphous silicon, protocrystalline silicon and nanocrystalline silicon), and Nanocrystalline solar cells Currently, often silicium or alumina oxides are used as barrier layers. However, these are too expensive because of the complex technology and high to ultra high vacuum. Furthermore, the layers are brittle.

It appeared that a combination of one or more organic compound layers as a under- and/or toplayer and one or more metal oxide layers does provide a better solution.

In another embodiment of the invention, stacks of organic compound layers can effectively protect sensitive devices. Preferably, the organic compound layers are stacked with intermediate leveling layers, like for example acrylate based coatings. Similarly, organic compound coatings are very suitable for flexible solar applications.

For example a Dye Solar Cell comprises a layer of nano-particulate titania (Titanium Dioxide) formed on a transparent electrically conducting substrate and photosensitized by a monolayer of dye. An electrolyte, based on an iodide-Tri-iodide redox system, is placed between the layer of photosensitized titania and a second electrically conducting catalytic substrate. This method can be used to produce flexible solar using flexible steel as the substrates. The laminate with active solar components (photovoltaic) can be laminated onto flexible steel. Alternatively the photovoltaic components can be directly printed on top of the steel substrates with the organic compound as barrier layer perhaps in combination with other transparent barrier layers such as those based on metal oxides. As the last layer the steel substrate may be coated with a layer coating as the protective top layer.

In one embodiment, organic compound is used as barrier layer in flexible solar applications, preferably as stacks with intermediate leveling layers.

In another embodiment, organic compound is used as barrier layer in rigid solar applications, preferably as stacks with intermediate leveling layers.

In yet another embodiment, crystalline organic compound layers are unexpectedly well suited for use as stacked barrier layers, optionally in combination with layers to decouple the organic compound layers like acrylates, for the encapsulation of flexible displays like liquid crystalline displays (LCD), or organic light emitting diode displays (OLEDs), or polymer light emitting displays (PLED), or electrophoretic displays, or electroluminescense displays (EL), or phosphorescent displays. In those flexible displays where semiconductor circuitry, albeit inorganic or organic semiconductor devices, is embedded, for example to drive the individual display elements (pixels or sub-pixels), such organic compound barrier layers in combination with decoupling layers can also be used to encapsulate these semiconductor devices. In the case of flexible displays, the flexible substrates, such as but not limited to PET, PEN or PES, can be repeatedly coated with a layer of organic compound and a decoupling layer, such as but not limited to, organic polymers, inorganic polymers, organometallic polymers, hybrid inorganic/organic polymer systems, and silicates. The sensitive display or optionally semiconductor device will be further applied adjacent to the organic compound barrier stack. For encapsulation of the optional semiconductor device another organic compound barrier stack is applied on top of the semiconductor device, on top of which the display device is applied. Another flexible substrate with a organic compound barrier stack is attached on top of the display device for encapsulation. In case a second flexible substrate to encapsulate the display device can be omitted like with OLED, PLED, EL or phosphorescent displays, the crystalline organic layer barrier stack can be applied directly in-line (in vacuum) on top of the sensitive display device to protect against moisture and oxygen.

In another embodiment where an OLED or PLED display is build upon a single rigid glass substrate without a glass or metal encapsulation, one or more organic compound layers in combination with one or more said decoupling layers can be directly coated in-line (in vacuum) on top of other OLED display stack as encapsulation. Additional layers, for example to provide a further improved water barrier, based on fluor compounds can also be coated in-line. Additional layers can be coated off-line to provide better protection.

In yet another embodiment, crystalline organic compound layers are unexpectedly well suitable for use as barrier layer, optionally in combination with other layers based on metal oxides, for production of (flexible) displays based on liquid crystalline compounds or organic light emitting diodes (OLEDs). In the case of flexible displays, the flexible substrates, such as PET, can be repeatedly coated with a layer of organic compound and a layer of metal oxides, such as silicium oxide or aluminum oxide or a combination thereof. In the case of rigid OLED displays, the organic compound layer can be directly coated in-line (in vacuum) on top of other OLED molecules as the protective layer. Additional layers, for example to provide a further improved water barrier, based on fluor compounds can also be coated in-line. Additional layers can be coated off-line to provide better protection. It furthermore appeared that stacks of organic compound layers can effectively protect sensitive devices. Preferably, the organic compound layers are stacked with intermediate leveling layers, like for example acrylate based coatings.

Similarly, organic compound coatings are very suitable for flexible electronics.

In another embodiment of the invention, the laminate or composite layer is used in or on displays or other electronic products, preferably flexible electronics products. One example of an electronic flexible product is a flexible display.

In another embodiment organic compound is applied as a barrier layer in displays (both flexible and rigid) based organic light emitting diode (OLEDs) and liquid crystalline displays. OLEDs compounds are particularly sensitive to the action of moisture and oxygen. In the current method of production of rigid displays. The OLED molecules are vapour deposited under vacuum. The final rigid display is sealed under vacuum to prevent the diffusion of oxygen and moisture into display unit. This method is quite expensive and time consuming. Surprisingly we have found that application of a crystalline organic compound, directly on top of the OLED molecules as the top layer, significantly increases the life time of such displays without the need to apply various types of sealing systems. It is also possible to coat the organic compound layer with various types of vapour depositable compounds such as fluorine based compounds, to increase the moisture barrier. A protective top coat can be applied off-line using various wet methods on top of the final stack of vapour depositable compounds (OLED/crystalline organic/fluorine compounds).

In another embodiment, crystalline organic compound layers are unexpectedly well suitable for use in pre-coated and top coated metallized paper for packaging. Current papers for metallization are special types of paper with the structure: Paper/clay coating/precoating/Alumina/topcoating. The paper is usually calendared to smooth the surface. Then a clay coating is applied by the paper manufacturer to smoothen the surface even more. This paper is then used for metallization. First, a pre-coat is applied to enhance adhesion of Al-layer, then an alumina layer is applied, and thereafter, a topcoat to induce printability. Both pre- and topcoat are applied off-line and very expensive. It appeared possible to apply special crystalline organic compound coatings like high temperature resistant compounds in-line both as pre-coat and topcoat. For this, a webcoater with three evaporation sources can be used. First, from a crystalline organic compound evaporator (pre-coat), a crystalline coating is applied, then Aluminum source, and then again an organic layer as topcoat. One of the two crystalline organic layers can be a triazine, as long as the other is not a triazine. The organic compounds are ideal materials in particular if they have high vapour pressure, i.e. upon deposition of Al, they do not sublime resulting in mixing of Al with organic compound vapour. The advantages are better barrier of Al and elimination of very tedious and expensive offline pre- and topcoat.

In another embodiment, crystalline organic compound layers are unexpectedly well suitable for use in an application as barrier coatings with desirable optical characteristics, i.e. these organic compounds do not absorb in long wavelengths (>500 nm). This is an advantage over inorganic transparent barrier materials. Potential applications are in electronic devices.

The crystalline organic vapour deposited layer can be used as dielectric layer (insulating layer) between two metal (deposited) layers; the metal can be for example chromium, zirconium, copper, gold or silver.

The film may consist of a homogeneous material, or it may itself be non-homogeneous or a composite material. The film may comprise various layers.

Preferably, the film comprises a polymeric material. Examples of polymeric compounds are thermoplastic compounds and thermosetting compounds. Suitable examples of thermoplastic compounds include polyolefins, polyolefin-copolymers, polyvinylalcohol, polystyrenes, polyesters and polyamides. Further preferred thermoplastic compounds are biodegradable polymers like poly-lactic acid (PLA), polyglycolideacid (PGA), co-poly lactic acid/glycolic acid (PLGA) and the like.

Suitable examples of non-degradable polymers include HD or LD polyethlylene (PE), LLD polyethylene, ethylene-propylene copolymers, ethylene-vinylacetate copolymer, polyproplylene (PP) and polyethylene terephtalate (PET). These thermoplastic compounds are often used in the form of a film, either as such or oriented; such orientation may be biaxial. Suitable examples include cast polypropylene (CPP), biaxially oriented polypropylene film (BOPP), biaxially stretched polyamide (BOPA). The film may also comprise a layer of paper.

The laminate preferably has a plastic film as substrate, and one laminating film. These plastic films may be the same or different, and preferably are both chosen from the list above.

The composite layer according the invention has favorable barrier properties, for example a low oxygen transmission rate (OTR) and a low water vapour transmission rate (WVTR), and is sufficient wear resistant. Therefore, the composite layer of the invention can be used as such in printing and laminating.

The OTR is generally measured in an atmosphere of 30° C. and 70% RH. The preferred values generally depend on the substrate. In case the substrate is 20 μm biaxially oriented polypropylene (BOPP), the OTR generally will be about 40 cc/m²·24 h or less, preferably about 30 cc/m²·24 h or less and even more preferred about 20 cc/m²·24 h or less. Generally, in case of BOPP, the OTR will be about 2 cc/m²·24 h or higher, and for example may be about 5 cc/m²·24 h or higher. The OTR can be measured with suitable apparatus, such as for example with an OXTRAN 2/20 manufactured by Modern Control Co. In case the substrate is a PET film, the OTR generally will be about 15 cc/m²·24 h or less, preferably about 10 cc/m²·24 h or less and even more preferred about 5 cc/m²·24 h or less. Generally, in case of BOPP, the OTR will be about 0.5 cc/m²·24 h or higher, and for example may be about 1 or 2 cc/m²·24 h or higher

Water vapour permeability (WVTR) can measured with a PERMATRAN 3/31 manufactured by Modern Control Co, in an atmosphere of 40° C. and 90% RH. The preferred values will depend on the substrate. For example for 20 pm BOPP the WVTR is generally about 3 g/m²·24 h or less, preferably about 2 g/m²·24 h or less, and more preferably about 1 g/m²·24 h or less. Generally, the vapour permeability will be about 0.1 g/m²·24 h or more, for example about 0.2 g/m²·24 h or more. For example for PET, the WVTR is generally about 8 g/m²·24 h or less, preferably about 7 g/m²·24 h or less, and more preferably about 4 g/m²·24 h or less. Generally, the vapour permeability will be about 0.5 g/m²·24 h or more, for example about 2 g/m²·24 h or more.

Preferably, the laminate has an OTR and WVTR also for other substrates which conform to the values given in the former two paragraphs.

The composite layer, optionally further processed by for example printing and laminating, can be applied as or to all kind of packing materials, for example bottles, paper, sheet and films. The packing material protects very well its content from for example oxygen, in this way increasing shelf life of food products or protecting electronic components from oxygen attack.

In one embodiment, the laminate comprises a PET or BOPP film as substrate, a metal or metal oxide layer on said substrate as barrier layer, a crystalline organic compound layer as protective and barrier layer on the metal layer, which organic compound layer has a pattern or figure, the laminate further comprising on the crystalline organic compound layer a pattern or figure and an adhesive and thereon a further film, which may be a polyolefin film, such as preferably a PE film.

The invention also relates to a process for applying an organic compound layer according to the invention on a substrate with a metal or metal oxide layer by vapour deposition of an organic compound comprising the steps of
a) applying a metal or metal oxide layer under reduced pressure, and
b) vapour depositing the organic compound on the metal or metal oxide layer while the film remains at reduced pressure.

In-line coating of a substrate with a metal or metal oxide layer with an organic compound in the same vacuum tool, but preferably a separate vacuum chamber yields a composite layer with a well activated alumina, so that sufficient adhesion is obtained if laminated, even after 3-6 month.

In one embodiment of the invention, a pre-coat is applied to the substrate before applying the metal or metal oxide. This has the advantage that the substrate has a more even surface, and/or the adhesion can be improved.

In one embodiment of the invention, the organic compound in the layer is for at least 80% crystallized, as measured by x-ray diffraction. Preferably the organic compound in the layer is for about 90% or more, even more preferably for about 95% or more, most preferably for about 98% or more crystallized.

In yet another embodiment, the metal or metal-oxide layer is treated with a silane coupling agent to increase the adhesion.

In yet another embodiment, the metal or metal-oxide layer is treated with a urethane polymer or polyester to increase the adhesion.

Preferably, the substrate is kept at a temperature of about 50° C. or lower.

Vapour-depositing as such is a process known to the skilled person. As vapour-depositing step is often carried out at a reduced pressure, i.e. a pressure below atmospheric pressure. In the process according to the invention, the pressure preferably is below about 1000 Pa (10 mbar), preferably below about 100 Pa (1 mbar) even more preferably below about 10 Pa (0.1 mbar). In case the deposition of the crystalline organic compound takes place in a chamber in which metal or a metal-oxide is deposited, it is more preferable to have a pressure of below about 1×10⁻² mbar although it is equally possible to reduce the pressure at which the vapour-depositing step is carried out even further. Generally, the vapour-depositing step is carried out at a pressure of about 1×10⁻³ Pa (10⁻⁵ mbar) or higher, preferably about 1×10⁻² Pa (10⁻⁴ mbar) or higher.

During the vapour-depositing step, the temperature of the substrate is about −60° C. or higher, preferably about −30° C. or higher, and even more preferable about −20° C. or higher, and most preferable about −15° C. or higher. The temperature of the substrate generally will be about +125° C. or lower, preferably about +100° C. or lower, even more preferably about +80° C. or lower, and most preferably about 30° C. or lower. The temperature of the substrate is defined herein as the temperature of the part of the substrate that is not being vapour-deposited. For example, if the vapour-depositing step is done on a film which is guided over a temperature-controlled coating drum, the temperature of the substrate is the temperature at which the coating drum is controlled, thus the temperature of the surface section of the film that is in immediate contact with the coating drum. In such a case, and in view of the fact that the to be deposited compounds often have a much higher temperature than 125° C., it will typically occur—as is known—that the temperature of the side of the substrate that is being deposited is higher than the temperature of the side that is not being deposited.

Methods to ensure that the substrate has a defined temperature are, as such, known. One such a method of ensuring that the substrate has a defined temperature is applicable in case there is at least one section, plane or side of the substrate where no layer is to be vapour-deposited; the said section, plane or side can then be brought into contact with a cooled or heated surface to bring the temperature to a desired level and keep it there. As an example, in case the substrate is a film and the vapour-depositing step is executed as a semi-continuous of continuous process whereby the layer will be deposited on one side of the film, the said film preferably is guided over a temperature-controlled roll, also known as coating drum, in such a fashion that the other side of the film—where no layer will be deposited—is in contact with the temperature-controlled roll before and/or during and/or following the vapour-depositing step.

The apparatus of the present invention is an apparatus for depositing a metal or metal-oxide and an organic compound under vacuum on a substrate, comprising winding rolls and at least one vacuum chamber with a metal or metal-oxide deposition part and an organic compound deposition part, the organic compound deposition part comprising an organic compound evaporator. The evaporator is preferably placed outside the vacuum chamber, but it is linked by a heated gas into the vacuum chamber. This has the advantage that the evaporator can stay at the operating temperature when the vacuum chamber is opened to place the next roll which is to be coated. In this way the effective cycle times can be increased.

Preferably, the organic compound deposition part comprises a cooling drum.

The invention will be further elucidated by the following non-limiting examples.

### EXAMPLES 1-6 AND COMPARATIVE EXPERIMENT 1

In a roll-to-roll coating apparatus equipped with a long heatable chamber coating experiments are performed. A biaxially oriented polypropylene film (BOPP) of 20 μm thickness is coated with aluminum (average thickness 28 nm), and subsequently with organic compound as shown in the table at a vacuum of about 0.01 mbar. The film speed is 5 m/sec. The alumina coated roll is stored for 6 month, and thereafter further processed. Some of the composite layers are further printed. All are laminated with a further plastic film in order to measure the lamination strength.

The lamination strength is measured according to JIS Z0238 with a Tensilon instron tester, at a speed: of 30 mm/min, the angle between the two films is 90 degree. As sealant (second film) LLDPE is used from Tohcello Co Ltd (TUX FCS), and as adhesive a reactive polyurethane in a solvent from Mitsui Takeda Chemicals (Takelac A-515 and Takenate A50, which are mixed just before use).

The Oxygen transmission rate (OTR) is measured with OXTRAN 2/20 manufactured by Modern Control Cop, in an atmosphere of 30° C. and 70% RH.

Vapour permeability is measured with a PERMATRAN 3/31 manufactured by Modern Control Co, in an atmosphere of 40° C. and 90% RH.

| | | | Lamination | OTR* of |
|---|---|---|---|---|
| | Organic | | strength | composite |
| Example | compound | Thickness | N/inch | layer |
| Comp Exp | None | — | 1.0 | Not |
| | | | | determined |
| 1 | hydroxybenzene- | 30 nm | 3.0 | 14 |
| | carboxilic acid | | | |
| 2 | adipic acid | 25 nm | 2.5 | 17 |
| 3 | 4,4-azoxyanisole | 30 nm | 3.0 | 22 |
| 4 | p-phenylphenol | 35 nm | 2.0 | 9 |
| 5 | benzenetriol | 30 nm | 3.0 | 34 |
| 6 | p-aminophenol | 15 nm | 3.5 | 14 |

*OTR in cc/m² · 24 h

### Example 6

In an analogues way laminates are made with a composite layer as described in Example 1. In the further lamination, an adhesive is applied on the organic compound layer, consisting of Novacote NC 275A and catalytic agent CA 12 (42.7 and 10.7 wt % respectively) and 46.6% ethyl acetate. The adhesive has a percentage of solid of 40%. The OTR after lamination is 12. The lamination strength>2.5 N/inch.

### Example 7

In a analogous way as in example 1, a plain PET film is treated by vapour deposition with 4,4-azoxyanisole. An improvement in oxygen barrier properties is observed.

1. Laminate comprising a substrate-layer and a plastic film and in between a vapour deposited organic compound layer other than a triazine compound and a metal or metal oxide layer, the laminate having a lamination strength of about 2 N/25 mm (inch) or more as measured in a 90 degree tensile testing at 30 mm/min.

2. Laminate comprising a substrate layer and a plastic film and in between a vapour deposited crystalline organic compound layer other than triazine, the laminate having a lamination strength of about 2 N/25 mm (inch) or more as measured in a 90 degree tensile testing at 30 mm/min, and wherein the crystalline organic compound improves the barrier properties of the laminate

3. Laminate according to claim 1 wherein the laminate comprises an adhesive layer between the organic compound layer and one of the plastic films.

4. Composite layer comprising a substrate, a metal or metal oxide barrier layer and a vapour deposited organic compound layer other than a triazine compound, the composite layer, when laminated on the organic compound layer with an adhesive and a plastic film being able to exhibit a lamination strength of about 2 N/25 mm (inch) or more as measured in 90 degree tensile testing at 30 mm/min.

5. Laminate or composite layer according to claim 1, wherein the substrate layer comprises a plastic film.

6. Laminate or composite layer according to claim 1, wherein the laminate comprises a printed pattern.

7. Laminate or composite layer according to claim 1, wherein the OTR as measured in an atmosphere of 30° C. and 70% RH, is about 20 cc/m²·24 h or less for laminates comprising BOPP as a substrate, or about 1 cc/m²·24 h with PET as a substrate.

8. Laminate or composite layer according to claim 1, wherein the water vapour permeability (WVTR) measured in an atmosphere of 40° C. and 90% RH is 2 g/m²·24 h or less for laminates comprising BOPP as a substrate, or about 5 g/m²·24 h or less with PET as a substrate.

9. A laminate or composite layer according to claim 1, wherein the adhesion is at least 2.5 N/inch, preferably at least 3 N/inch.

10. A laminate or composite layer according to claim 1, wherein the organic compound is any organic compound apart from a crystalline triazine compound having a vapour pressure of 1 Pa (0.01 mbar) or higher at 30° C. below its decomposition temperature and of about 1000 Pa or lower.

11. A laminate or composite layer according to claim 1, wherein the compound is crystalline, and has a Tm>50° C., preferably >100° C.

12. A laminate or composite layer according to claim 1, wherein the organic compound has a Tg or rubbery-to-plastic phase-transition, of 70° C. or more, preferably 100° C. or more.

13. A laminate or composite layer according to claim 1, wherein The Mw of the organic compound is about 1000 or lower.

14. A laminate or composite layer according to claim 1, wherein the organic compound is not polymerized on the surface.

15. A laminate or composite layer according to claim 1, wherein the organic compound is non-aliphatic, and it has ether, ester, amide, ketone groups and the like, such that the compound is sufficient polar to adhere well to the substrate

16. A laminate or composite layer according to claim 1, wherein the metal or metal oxide layer is a layer from aluminium, aluminium oxide, magnesium oxide or silicium oxide.

17. Use of a vapour deposited organic compound on a metal coated film in order to lower the amount of de-activation.

18. Use of a vapour deposited crystalline organic compound apart from a triazine compound, on a plastic film to increase barrier properties.

19. Use of claim 17, wherein the organic compound is any organic compound apart from a crystalline triazine compound having a vapour pressure of 1 Pa (0.01 mbar) or higher at 30° C. below its decomposition temperature and of about 1000 Pa or lower.

20. Use according to claim 17, wherein the compound is crystalline, and has a Tm>50° C., preferably >100° C.

21. Use according to claim 17, wherein the compound is in the form of a continuous crystalline layer.
